(19) United States
(12) Patent Application Publication
(10) Pub. No.: US 2024/0239446 A1
(43) Pub. Date: Jul. 18, 2024

(54) TUBULAR WIND TURBINE COMPONENT SUPPORT FOR LARGE TUBULAR WIND TURBINE COMPONENTS

(71) Applicant: Heerema Marine Contractors Nederland SE, Leiden (NL)

(72) Inventor: Paul Antonius Alphonsus GEENE, Leiden (NL)

(21) Appl. No.: 18/574,550

(22) PCT Filed: Jun. 29, 2022
(86) PCT No.: PCT/EP2022/067964

§ 371 Date: Dec. 27, 2023

(30) Foreign Application Priority Data
Jun. 29, 2021 (NL) 2028568

(51) Int. Cl. B63B 25/28; B63B 77/10; F03D 13/40

(52) U.S. Cl. CPC B63B 25/28; B63B 77/10; F03D 13/402; F05B 2240/95

(57) ABSTRACT

Support assembly for transporting a tubular wind turbine component, the support assembly defining a contour and a longitudinal axis, corresponding to that of a tubular wind turbine component in a tubular wind turbine component position, and wherein the support assembly comprises:—a saddle adjoining a lower part of the contour, wherein the longitudinal axis is oriented transversally to the saddle, —a first fixing point and a second fixing point for attaching a first flexible restraint, —the first flexible, wherein the first fixing point, the second fixing point and the contour define a first restraint path along which in use the first flexible restraint extends over the tubular wind turbine component and contacts its outer surface, characterized in that when viewed in a direction of the longitudinal axis the first fixing point is located: #left of the longitudinal axis, #below an upper horizontal tangent of the contour, and #not vertically underneath the contour, wherein in use the first restraint path extends from the first fixing point to a first contact point on the turbine component, over the tubular wind turbine component and along the surface of the tubular wind turbine component and beyond an outer right vertical tangent of the tubular wind turbine component to a second contact point on the outer surface where the flexible restraint extends away from the outer surface to the second fixing point, wherein at least a part of the first restraint path is oriented along a tangent to the contour passing through the second contact point.

### FIELD OF THE INVENTION

The field of the invention relates to the transport and sea fastening of large tubular wind turbine components

### BACKGROUND OF THE INVENTION

In the field of transporting and sea fastening large tubular wind turbine components various devices and methods exist. Because wind turbine generators are increase in size, the foundations and masts of the turbine are also increasing in size. While diameters are increasing, wall thickness is relatively decreasing; where in the past a ratio between the two of 120 was considered high, presently diameter over wall thickness ratios are reaching the 200 mark. In order to safely transport these components without damaging them, reliable and safe support structures must be provided that may be used under various wind and sea conditions

A solution that is regularly used exists in the form of saddles that support the components over a large part of their circumference. However, because the components are getting larger, the saddles must also become larger and heavier to be able to support the components and to be able to cope with the load and the deformation inflicted upon the components. Besides saddles, hydraulic clamps have also been used to secure the components, sometimes together with saddles. Similar to saddles, hydraulic components are also heavy, costly, and, on top of that, are susceptible to malfunctioning.

EP3575199A1 attempts to overcome at least several of these drawbacks by providing a somewhat simpler device. The device comprises a frame having two upwardly oriented towers. Each tower comprises an engagement block and a connecting point for a flexible element. In one of the towers a pivotable element is provided to which the engagement block and connecting point are connected. A slacking flexible element is provided between the connecting points of both towers in a similar manner to a hammock. In use, a monopile is lowered onto the flexible element. A downwardly oriented gravitational force is then exerted on the flexible element which pulls the engagement blocks against the surface of the monopile. This secures the monopile in place. The flexible elements extend underneath the monopile.

In the present invention the insight was developed that the disclosed device has a number of drawbacks. One of these drawbacks is the use of a pivotable member to which the flexible element is connected. When the monopiles are oriented in a transverse direction to the longitudinal direction of the vessel, the pivot axis of the pivotable member will also be oriented in this direction. When the vessel will move in a lateral direction, e.g., rolling motion, the pivotable members will be repeatedly loaded and unloaded in a prying motion. This may excessively wear the pivotable member and/or the pivotable member must be very durably built. This increases the cost of the system.

Similarly, when monopiles are oriented in the longitudinal direction of the vessel in order not to extend outboard of the vessel, a similar situation will occur due to pitch forces. Also, in severe weather and under roll conditions, the monopiles may move laterally because of their inertia and a lack of retaining elements in the lateral direction other than their own weight.

Because the engagement blocks and/or the connecting points have to be located at a certain height for the flexible element to be able to support the monopile in a lateral direction, the towers also have to be at least as high as the connecting point. This results in a high construction in which loads act on the highest point of the construction. Because this creates a large arm, the moments that act on the towers are also large. This increases inertia loads on the towers, the weight of the towers, and the cost of the towers.

Also, because the towers must extend alongside the monopile, sufficient distance must be kept between two adjacent monopiles on a vessel; at least one tower must extend upwardly in between the two monopiles. The structure therefore occupies a large amount of deck area.

Another drawback which was recognized is that the supporting elements are flexible. If a force acts on the monopile in its longitudinal direction, the monopile is almost entirely free to move laterally in this direction. The only elements hindering that movement are the four engagement blocks that may offer a friction force. It is believed that such a small contact surface will not be effective to prevent this motion. Further, because the engagement blocks are relatively small, they may also create a highly concentrated load and damage the monopiles.

WO2015/187031A1 discloses a system for supporting and securing pipes on a deck of a vessel. In WO2015/187031A1, multiple pipes are simply laid on deck and on top of each other. This creates point concentrated loads on the pipes, when seen in cross-section. Monopiles of wind turbines are not designed to withstand such point concentrated loads and the system of WO2015/187031A1 is not suitable for monopiles for this reason alone.

Furthermore, the pipes are supported laterally as a group by supports 30 and 50 on a left and right side of a deck. A securing cable 26 is provided over a group of monopiles. However, for individual pipes there is no lateral support which prevents the pipes from deforming into a flatter, oval shape. If the pipes are placed on deck one by one during loading, there will be a time period in which at least some pipes do not have any lateral support. Monopiles have a relatively thin wall and are vulnerable to excessive deformation. Hence, the system of WO2015/187031A1 may cause excessive deformation and damage and is not suitable for monopoles or other tubular components of wind turbines.

AU528400B2 relates to a support system for piping. The system comprises a frame that is connected to a base or to the ground and comprise two upwardly oriented diverging elements at an upper side of the frame. A sling is connected to the two diverging elements and a pipe is positioned in the sling, the sling acting as a hammock. Subsequently, a tie down sling may be placed over the pipe to tie down the pipe into the original sling.

The piping that is supported by the support system is suspended in a hammock by the lower sling and tied down by the upper tie down sling. Because the slings are flexible elements, the pipe is not fixated and it may move laterally within elastic boundaries of the two slings.

Longitudinal movement appears to be prevented by the shear length op piping: moving the piping in a longitudinal direction would mean that the entire length of piping, potentially being kilometres long, would have to move. If a relatively short pipe were to be supported by the system, a longitudinal movement would be possible within the elastic boundaries of the slings.

It has been recognized that either a longitudinal or lateral movement of a tubular wind turbine components on a vessel would be detrimental to the operation of such a vessel.

Further, because the slings are made out of tensile wire, stress concentrations may occur at the slings. While this may not be a large problem for smaller diameter piping, this would cause significant problems for large and heavy tubular wind turbine components.

DE4123430C1 relates to a plastic pipe or cable holding element. The holding element comprises two opposing shell parts that are connected to each other on a lower side. A resilient piece is connected to the lower side and to an upper side of each of the shell parts. When a pipe or cable is placed in the holding element, the upper parts of the two shell parts can be joined, enclosing and suspending the pipe or cable in the resilient piece.

It has been recognized that the holding element in itself is not suitable for the transport of tubular wind turbine components, because of its scale and the used materials.

Further, a resilient piece is configured to keep the pipe or cable in place. Besides the fact that it will be very difficult to find a resilient piece that is suitable to support a large tubular wind turbine component such as a monopile or mast, the idea behind the resilient piece also isn't applicable to tubular wind turbine components. Because the component is suspended in an elastic member, the component is moveable in all directions. As has been previously discussed, this is detrimental to the operation of a transport vessel and gives rise to potentially very complex load cases on the components.

### OBJECT OF THE INVENTION

It is an object of the invention to provide a device and a corresponding method that reduces at least one of the abovementioned drawbacks.

It is a further object to provide a device and a corresponding method to support tubular wind turbine components in an efficient and effective manner.

It is a further object to provide a device and a corresponding method to transport tubular wind turbine components over water (seas, oceans, etc.) without damaging the tubular wind turbine components.

### SUMMARY OF THE INVENTION

In one aspect, the invention relates to a support assembly for transporting a tubular wind turbine component, the support assembly defining a tubular wind turbine component position having a contour and a longitudinal axis, wherein the contour corresponds to an outer surface of the tubular wind turbine component that in use is located in the tubular wind turbine component position and the longitudinal axis corresponds to a longitudinal axis of the tubular wind turbine component that in use is located in the tubular wind turbine component position, wherein the tubular wind turbine component is a turbine mast or a monopile, and wherein the support assembly comprises:
a saddle adjoining a lower part of the contour of the tubular wind turbine component position, wherein the longitudinal axis of the tubular wind turbine component position is oriented transversally to the saddle, and wherein the saddle is configured to abut against an outer surface of a wall of a tubular wind turbine component in the tubular wind turbine component position,
a first fixing point and a second fixing point for attaching respectively a first end and a second end of a first flexible restraint, wherein the first fixing point and the second fixing point are configured to be fixed relative to the saddle,
the first flexible restraint comprising the first end and second end, wherein the first fixing point, the second fixing point and the contour define a first restraint path along which in use the first flexible restraint extends, wherein in use the first restraint path extends over the tubular wind turbine component between the first fixing point and the second fixing point and contacts an outer surface of the tubular wind turbine component,

characterized in that when viewed in a direction of the longitudinal axis of the tubular wind turbine component position the first fixing point is located:
on the left of the longitudinal axis, and
below an upper horizontal tangent of the contour, and
not vertically underneath the contour,

wherein in use the first restraint path extends from the first fixing point to a first contact point on the outer surface of the tubular wind turbine component in the tubular wind turbine component position, from the first contact point over the tubular wind turbine component and along the surface of the tubular wind turbine component and beyond an outer right vertical tangent of the tubular wind turbine component position to a second contact point on the outer surface where the flexible restraint extends away from the outer surface, and from the second contact point to the second fixing point,

wherein at least a part of the first restraint path extending between the second contact point and the second fixing point is oriented along a tangent to the contour passing through the second contact point,

wherein the first flexible restraint is configured to reduce local stress concentrations by reducing a deformation of the tubular wind turbine component when a force towards the right, in particular an inertia force resulting from a rolling movement of a vessel or barge on which the tubular wind turbine component is transported, acts on said tubular wind turbine component, wherein the first flexible restraint limits an increase in length of the first restraint path resulting from a deformation of said tubular wind turbine component.

The specific location of the first fixing point and the first restraint path are important to not only immobilize the tubular wind turbine component, but especially to reduce deformation of the component when a lateral load acts upon it.

The words “beyond an outer right vertical tangent of the tubular wind turbine component position to a second contact point on the outer surface” indicate that the second contact point is further than the outer right point of the tubular wind turbine component position, when travelling along the flexible restraint from the first contact point toward the second contact point. The second contact point may be located on the lower half of the tubular wind turbine component position, in particular in a lower right quarter of the tubular wind turbine component position.

It is noted that the words left and right are used to define the invention. The skilled person will understand that a mirror version in which left and right are mirrored is also possible and is intended to also fall within the scope of the claims.

The invention may be explained by comparing the tubular wind turbine component to a thin-walled cylinder such as a paper tube. If one were to restrain a tubular component wherein the first fixing point is located on the right of the longitudinal axis when viewed along the longitudinal axis and the restraint path would extend towards the right side of the tubular component, and a force to the right would act on the tubular component, the tubular component would be pressed into the first flexible restraint and would be free to deform in the vertical direction becoming egg-shaped, e.g. it would become an upwardly oriented oval.

If one were to restrain a tubular component wherein the first fixing point is located on the left of the longitudinal axis but above an upper horizontal tangent when viewed along the longitudinal axis and the restraint path would extend towards the right side of the tubular component, and a force to the right would act on the tubular component, the same egg-shape would be obtained because a vertical deformation is still free to occur.

If one were to restrain a tubular component wherein the first fixing point is located on the left of the longitudinal axis, below an upper horizontal tangent, and vertically underneath the tubular wind turbine component position when viewed along the longitudinal axis and the restraint path would extend towards the right side of the tubular component, and a force to the right would act on the tubular component, the component would not only be free to deform, it would also be able to move towards the right in a direction of the force.

However, if one were to restrain a tubular component wherein the first fixing point is located on the left of the longitudinal axis, below an upper horizontal tangent, and not vertically underneath the tubular wind turbine component position when viewed along the longitudinal axis and the restraint path would extend towards the right side of the tubular component, and a force to the right would act on the tubular component, the restraint would keep the component in place and would reduce any deformation resulting from the force.

The force acting on the tubular component creates a hoop stress in the tubular component, wherein any point right of an apex of a cross-section of the tubular component wants to move away from the centre of the tubular component. Because the location of the first fixing point causes the restraint path to extend to a contact point on an outer surface of the tubular component that is located left of the apex, each point wanting to move away from the centre is restrained by the flexible restraint. Because the tensile stress in the flexible restraint is in equilibrium with the hoop stress in the tubular component, deformation is reduced. This phenomenon is comparable to suspending a thin-walled cylinder in a hammock-like structure: the vertical gravitational force acting on the cylinder causes a reaction force in the hammock. Because the vertical gravitational force is counteracted by a radial force exerted by the hammock, the horizontal component of the radial forces cancels out with the horizontal forces that want to compress and laterally expand the cylinder under influence of gravity.

Besides being lightweight and cheap, because it suffices to fix or loosen the flexible restraint to restrain or release a tubular wind turbine component, no large and heavy part will have to be moved around to restrain or release a tubular wind turbine component when in use. Also, no structural amendments such as the welding of attachment pieces to the tubular wind turbine components or locally reinforcing the tubular wind turbine components is necessary. For example, instead of attaching an eye via welding or bolting to the tubular wind turbine component and attaching a lashing to that eye, wherein the tension from the lashing would be very locally transferred into the wall of the tubular wind turbine component via the eye, now the tension remains in the sling and only the reaction force to the sling is transferred into the pile.

Further it is noted, where a typical saddle is difficult to adjust to match fabrication tolerances (roundness/diameter). Restraints, when used in conjunction with tensioning elements to take out slack or to pretension, do not have this issue. Restraints will follow the contour of the tubular element. This means that all tubular elements will be restrained in the same manner thus not requiring to take into account all the deviations into the design.

Also, where a saddle is typically an item that is made suiting only minimal diameter variations, it is thus often considered to be project specific; investing large amounts of funds in these one-time-use items is not beneficial. A possibility to lower the stresses using only a saddle is to either increase the saddle length and/or increase the saddle height (greater part of the circumference supported). This also increases weight and cost. In contrast, by using flexible restraints to restrain the tubular elements, the size of the saddles can be reduced as most of the horizontal load is taken up by the restraint(s). Where the restraints are only defined by a length and capacity and can thus be re-used for different sizes of tubular elements.

Further, when considering a load-case where there is negative heave (i.e. the vessel is moving downwards) and thus a reduced gravity is observed while having a large horizontal load (resulting from roll) transverse to the tubular, typically a tubular element wants to creep/roll up to the upper edge of the saddle thus allowing further deformation with the result that the saddle is thus limited in keeping the tubular in its natural form. In contrast, when restrained using the flexible restraints and subjected to large horizontal loads, the restraints actively pull the tubular back towards the saddle, further aiding in keeping the tubular more in its natural form and thus further decreasing stresses in the tubular element. When flexible restraints are positioned near saddles, they jointly function somewhat similar to ring stiffeners while restraining it.

Besides the significant reduction in local stresses near the saddle that are in the order of three to four times as small, the flexible restraints also greatly impact global pile behaviour. Because they act as ring stiffeners for the tubular wind turbine component, the overall deformation of the entire component is also greatly reduced.

Further, it is noted that when looking along the longitudinal direction from a first side the device is perceived as described above and when looking from along the longitudinal direction from a second side, the directions and locations are mirrored, i.e., the force would be acting towards the left and the fixing point would be located on the right.

Also, even though the abovementioned device may well be beneficially used for a wind turbine mast, a larger advantage is present for a wind turbine monopile because the monopile has a significantly larger diameter and problems associated with conventional transport methods are significantly larger for the larger monopiles than for masts.

In an embodiment, the support assembly, further comprising at least a second flexible restraint having the same features as the first flexible restraint, but mirrored around a mirror axis or about a mirror plane on a vertical plane which extends through the longitudinal axis, said features being, when viewed along the longitudinal axis of the tubular wind turbine component position;
a third fixing point and a fourth fixing point for attaching respectively a first and second end of the second flexible restraint, wherein the third fixing point and the fourth fixing point are configured to be fixed relative to the saddle,
the second flexible restraint comprising the first end and second end, wherein the third fixing point, the fourth fixing point and the contour define a second restraint path along which in use the second flexible restraint extends, wherein in use the second restraint path extends over the tubular wind turbine component between the third fixing point and the fourth fixing point and contacts the outer surface of the tubular wind turbine component,
wherein when viewed in a direction of the longitudinal axis of the tubular wind turbine component position the third fixing point is located:
   on the right of the longitudinal axis, and
   below an upper horizontal tangent of the contour, and
   not vertically underneath the contour,
wherein in use the second restraint path extends from the third fixing point to a third contact point on the outer surface of the tubular wind turbine component in the tubular wind turbine component position, from the third contact point over the tubular wind turbine component and along the surface of the tubular wind turbine component past an outer left vertical tangent of the tubular wind turbine component position to a fourth contact point on the outer surface where the flexible restraint extends away from the outer surface, and from the fourth contact point to the fourth fixing point,
wherein at least a part of the second restraint path extending between the fourth contact point and the fourth fixing point is oriented along a tangent to the tubular wind turbine component position passing through the fourth contact point,
wherein the first and second flexible restraints are configured to reduce local stress concentrations by reducing a deformation of a tubular wind turbine component in the tubular wind turbine component position when a lateral force, in particular an inertia force resulting from a rolling movement of a vessel or barge on which the tubular wind turbine component is transported, acts on said tubular wind turbine component, wherein the first and second flexible restraints limit an increase in length of the first and second restraint paths resulting from a deformation of said tubular wind turbine component.

The use of at least a second flexible restraint mirrored with respect to the first flexible restraint permits the reduction of deformation when a force is acting on the tubular wind turbine component regardless of the direction (to the left or to the right) of the force.

In an embodiment, the second contact point is located past an outer right saddle point when viewed along the first restraint path from the first fixing point to the second fixing point, and/or the fourth contact point is located past an outer left saddle point when viewed along the second restraint path from the third fixing point to the fourth fixing point.

Even though the device works without the second and/or fourth contact points being located past outer saddle points, when the second and/or fourth contact points are located past outer saddle points, the device works even better. The presence of a support in the form of a flexible restraint or the saddle over the entire surface of a tubular wind turbine component on an opposite side of the apex relative to the first and/or third fixing point enhances the further reduction of deformation of the tubular wind turbine component.

In an embodiment, the first contact point and the second contact point are located at a circumferential angle of 150-210 degrees from each other over the outer surface of the tubular wind turbine component, in particular 165-195 degrees, more in particular 180 degrees, and/or the third contact point and the fourth contact point are located at a circumferential angle of 150-210 degrees from each other over the outer surface of the tubular wind turbine component, in particular 165-195 degrees, more in particular 180 degrees.

By creating a contact area over the mentioned circumferential angle, the restraint is better able to reduce deformation of the tubular component when in use.

In an embodiment, the saddle defines a recess.

In some embodiments, the recess has a shape of a part of a circle which, in particular, substantially corresponds to a diameter of a tubular wind turbine component for which the saddle is intended to be used. Such a shape creates a good support for a lower part of a tubular wind turbine component in the tubular wind turbine component position and lateral loads may have less effect and the deformation of the tubular wind turbine component in the tubular wind turbine component position.

In an embodiment, the saddle has a shape of a part of a circle, in particular of a circumferential angle of at least 70 degrees, more in particular 100-180 degrees, even more in particular 100-140 degrees. By using different circumferential angles, the loads acting on the flexibles restraints may be controlled.

In an embodiment, the first fixing point is located at a first longitudinal distance from the second fixing point when viewed along the longitudinal axis of the tubular wind turbine component, allowing the part of the first flexible restraint which in use contacts the tubular wind turbine component to have a first helical shape, in particular the first fixing point being located on a front side or a rear side of the saddle and the second point being located on the other side than the first fixing point.

In an embodiment, the third fixing point is located at a second longitudinal distance from the fourth fixing point when viewed along the longitudinal axis of the tubular wind turbine component position, allowing the part of the second flexible restraint which in use contacts the tubular wind turbine component to have a second helical shape, in particular the third fixing point being located on a front side or a rear side of the saddle and the fourth point being located on the other side than the third fixing point.

By placing the first and second fixing points apart over a first distance and/or by placing the third and fourth fixing points apart over a second distance, a large capacity is created to let the flexible restraints take up loads in a longitudinal direction of the tubular wind turbine component position.

In an embodiment, the first longitudinal distance is 75-125% of the second longitudinal distance, in particular 85-115%, even more in particular 100%.

In an embodiment, the first helical shape has a first pitch and the second helical shape has a second pitch, and wherein the first pitch and/or the second pitch are less than 200% of the diameter of the contour, in particular less than 150%, even more in particular less than 100%.

In an embodiment, at least one fixing point is located on the saddle.

In an embodiment, the support assembly further comprises a fixing frame, wherein the saddle is connected to the fixing frame and at least one fixing point is located on the fixing frame.

In an embodiment, at least one flexible restraint is made from a metal strip. Because such a strip is not considered to be a lashing, it may be used in a variety of conditions where lashing are not allowed.

At least one flexible restraint may also be made from a material with a high elasticity modulus, in particular from UHMWPE, more in particular from Dyneema.

In an embodiment, at least one flexible restraint comprises a gripping member having a gripping surface, comprises a gripping layer or comprises a gripping coating, configured to, when in use, prevent the slipping of the at least one restraint relative to a tubular wind turbine component in the tubular wind turbine component position.

Such a gripping member can be a coating, a sleeve, or components of an intermediary material. Other gripping members are possible as well.

In an embodiment, the saddle comprises a plurality of support pads. Herein a tubular wind turbine component does not need to lay on bare metal of a saddle and an outer surface of a tubular wind turbine component is less likely to be damaged.

In an embodiment, the saddle comprises a continuous support surface. Such a continuous surface provides low stress concentrations because there is as much contact surface between the saddle and the tubular wind turbine component.

In an embodiment, the plurality of support pads are made of a resilient material, in particular rubber. Such a material may be well suited to grip the tubular wind turbine component.

The pads may be curved but may also be straight. When curved, the pads may be circular or oval or have a different curved shape.

The pads may be evenly spaced, but may also be concentrated over sections of the saddle. Pads can also be evenly spaced but have a section, for example at the 6 'o-clock position, where no pads are present.

In an embodiment, the continuous support surface or the plurality of support pads comprise a slippery surface configured to allow a tubular wind turbine component to slide over the surface in at least a longitudinal direction without transferring a substantial longitudinal force onto the saddle.

Such a slippery surface may be useful for a single support assembly, but also when multiple tubular wind turbine component support assemblies support a tubular wind turbine component. When the support assemblies are fixed to a surface and the tubular wind turbine component extends in a longitudinal direction or the surface extends in a longitudinal direction, the slippery surface may allow the tubular wind turbine component to slide over the saddle. This creates a simply supported beam construction. In doing so, loads and therefore deformations in the tubular wind turbine components are reduced.

In a further aspect, the invention relates to a combination of at least a first support assembly according to any of the previous claims and a second support assembly according to any of the previous claims, wherein the second support assembly is located at a longitudinal distance from the first support assembly. Such a combination would provide a statically determinate support structure for the tubular wind turbine component.

In an embodiment, the combination comprises a first saddle and a second saddle and not a third saddle. By not using a third saddle, the combination remains statically determinate, i.e., the use of a third saddle would render the combination statically indeterminate and would potentially create unnecessary loads and deformation in the tubular wind turbine component.

In an embodiment, the combination also comprises an end stop being located at a longitudinal distance from the first support assembly, the first support assembly being located between the end stop and the second support assembly. Herein, the end stop is configured to transfer a longitudinal force onto a top end or a bottom end of the tubular wind turbine component in the tubular wind turbine component position which prevents the tubular wind turbine component from sliding in the longitudinal direction.

In an embodiment, the combination is further configured for restraining multiple tubular wind turbine components in as many multiple tubular wind turbine component positions, the combination comprising at least one support frame comprising a front portion and a rear portion, wherein the front portion is configured to support one end of a tubular wind turbine component of a plurality of tubular wind turbine components and the rear portion is configured to support another end of a tubular wind turbine component of a plurality of tubular wind turbine components. Herein, the front portion comprises a plurality of tubular wind turbine component support assemblies according to any of claims 1-18 wherein each support assembly is connected to the at least one support frame, and wherein each fixing point is fixed to the saddle or to the fixing frame or to the support frame. The rear portion may comprise a plurality of tubular wind turbine component support assemblies according to any of claims 1-18, wherein each support assembly is connected to the at least one support frame, and wherein each fixing point is fixed to the saddle or to the fixing frame or to the support frame.

Such a combination allows the simultaneous supporting of a number of tubular wind turbine components. In particular, such a combination would be well suited for the simultaneous transport of multiple tubular wind turbine components.

In an embodiment, a connection of a support assembly to the support frame comprises a first compliant component that is configured to create at least one degree of freedom between the support assembly and the support frame, wherein the first compliant component is a torsion spring, tension spring, or compression spring.

In some embodiments, the saddle has a recess having a radius of curvature R1 which is greater than a radius of curvature R2 of the tubular wind turbine component in a non-deformed state. It was found that this limits local deformations and tensions in the wall of the tubular wind turbine component near the outer ends of the saddle. Also, the saddle may be used for tubular wind turbine component of different diameters.

In some embodiments, a lower part of the recess of the saddle has a radius of curvature R1 which is equal to a radius of curvature R2 which the tubular wind turbine component adopts when deformed under its own weight after being positioned in the saddle, and wherein a left upper part and a right upper part of the saddle have a radius of curvature R3 which is greater than a radius of curvature R2 which the tubular wind turbine component adopts at the left upper part and the right upper part when deformed under its own weight, wherein the tubular wind turbine component contacts the recess in the lower part and does not contact the saddle in the left upper part and right upper part. It was found that this further limits deformations and tensions in the wall of the tubular wind turbine component near the outer ends of the saddle. Also, the saddle may be used for tubular wind turbine component of a greater range of diameters.

In some embodiments, the recess of the saddle has a height H2, measured from a lowest point of the recess to outer left and right saddle points and wherein the tubular wind turbine component contacts the saddle over a height H3, and wherein H3/H2 is in a range of 0,1-0,5. It was found that this embodiment strikes a good balance between on the one hand limiting deformations and tensions in the wall of the tubular wind turbine component and on the other hand limiting the movements of the tubular wind turbine component during transport.

In an embodiment, the support frame comprises a second compliant component that is configured to create an internal degree of freedom in the support frame wherein the second compliant component is a torsion spring, tension spring, or compression spring.

Similar to the saddle comprising a slippery surface, a compliant component may permit a relative movement of the tubular wind turbine component with respect to the support frame. This may reduce loads and deformations in the tubular wind turbine component.

In an embodiment, the first compliant component and/or the second compliant component further comprise a damper.

In an embodiment, the first compliant component and/or the second compliant component is located at the rear portion of the support frame.

In a further aspect, the invention relates to an assembly of a least one support assembly according to any of claims 1-18 and a tubular wind turbine component being a turbine mast or a monopile, wherein the tubular wind turbine component abuts against the saddle in the tubular wind turbine component position and wherein at least the first flexible restraint extends over the tubular wind turbine component between the first fixing point and the second fixing point along the first restraint path.

In an embodiment, at least the second flexible restraint extends over the tubular wind turbine component between the third fixing point and the fourth fixing point along the second restraint path.

In a further aspect, the invention relates to a vessel for the transporting of tubular wind turbine components, comprising a support assembly according to any of claims 1-18, a combination according to any of claims 19-26, and/or an assembly according to any of claims 27-28. Such a vessel may be a ship, a barge, or a semi-submersible. Other vessel types are also possible.

In an embodiment, at least a first support assembly is translationally connected to the vessel in a longitudinal direction forming a free bearing and wherein another support assembly forms a fixed bearing and is located at a distance from the first support assembly, wherein the fixed bearing and the free bearing are configured to allow hogging and/or sagging of the vessel without a substantial load transmittal into the tubular wind turbine component.

In a situation wherein both a first and a second tubular wind turbine component would be fixed to the vessel, when the vessel would hog or sag, a significant load would be applied to the tubular wind turbine components which would be undesirable.

In a further aspect, the invention relates to a method for transporting a tubular wind turbine component with a support assembly, the support assembly defining a tubular wind turbine component position having a contour and a longitudinal axis, wherein the contour corresponds to an outer surface of the tubular wind turbine component that is located in the tubular wind turbine component position and the longitudinal axis corresponds to a longitudinal axis of the tubular wind turbine component that in use is located in the tubular wind turbine component position, wherein the tubular wind turbine component is a turbine mast or a monopile, and wherein the support assembly comprises:
a saddle adjoining a lower part of the contour of the tubular wind turbine component position wherein a longitudinal axis of the tubular wind turbine component position is oriented transversally to the saddle, and wherein the saddle is configured to abut against an outer surface of a wall of the tubular wind turbine component in the tubular wind turbine component position, a first fixing point and a second fixing point for attaching respectively a first and second end of a first flexible restraint, wherein the first fixing point and the second fixing point are configured to be fixed relative to the saddle,
wherein when viewed in a direction of the longitudinal axis of the tubular wind turbine component position the first fixing point is located:
   on the left of the longitudinal axis, and
   below an upper horizontal tangent of the contour, and not
   vertically underneath the tubular wind turbine component position,
wherein the method comprises the steps;
a) placing a tubular wind turbine component in the tubular wind turbine component position defined by the saddle,
b) fixing the first end of the first flexible restraint at one of the first fixing point or second fixing point,
c) passing the first flexible restraint over the tubular wind turbine component along a first restraint path,
d) fixing the second end of the first flexible restraint at the other of the first fixing point or second fixing point,
characterized in that the first restraint path extends from the first fixing point to a first contact point on an outer surface of the tubular wind turbine component in the tubular wind turbine component position, from the first contact point over the tubular wind turbine component and along the surface of the tubular wind turbine component past an outer right vertical tangent of the tubular wind turbine component position to a second contact point on the outer surface where the flexible restraint extends away from the outer surface, and from the second contact point to the second fixing point,
wherein at least a part of the first restraint path extending between the second contact point and the second fixing point is oriented along a tangent to the tubular wind turbine component position passing through the second contact point,
wherein the first flexible restraint is configured to reduce local stress concentrations by reducing a deformation of a tubular wind turbine component in the tubular wind turbine component position when a force towards the right, in particular an inertia force resulting from a rolling movement of a vessel or barge on which the tubular wind turbine component is transported, acts on said tubular wind turbine component,
wherein the first flexible restraint limits an increase in length of the first restraint path resulting from a deformation of said tubular wind turbine component.

By being able to use a relatively lightweight flexible restraint it is possible to transport tubular wind turbine components in a cost effective and efficient manner. The use of a flexible restraint offers benefits over large steel structures because of its smaller weight, size, material, and relative ease of use.

Similar to the device, the method may be execute viewed along a longitudinal direction of the tubular wind turbine component position from one end, but also viewed from the other end.

In an embodiment, the support assembly further comprises at least a second flexible restraint having the same features as the first flexible restraint, but mirrored around a mirror point or about a mirror plane on a vertical plane which extends through the longitudinal axis, said features being, when viewed along the longitudinal axis of the tubular wind turbine component position;
a third fixing point and a fourth fixing point for attaching respectively a first and second end of the second flexible restraint, wherein the third fixing point and the fourth fixing point are configured to be fixed relative to the saddle,
wherein when viewed in a direction of the longitudinal axis of the tubular wind turbine component position the third fixing point is located:
   on the right of the longitudinal axis, and
   below an upper horizontal tangent of the contour, and not
   vertically underneath the contour,
wherein the method further comprises the steps;
e) fixing the first end of the second flexible restraint at one of the third fixing point or the fourth fixing point,
f) passing the second flexible restraint over the tubular wind turbine component along a second restraint path,
g) fixing the second end of the second flexible restraint at the other of the first fixing point or second fixing point,
wherein the second restraint path extends from the third fixing point to a third contact point on the outer surface of the tubular wind turbine component in the tubular wind turbine component position, from the third contact point over the tubular wind turbine component and along the surface of the tubular wind turbine component past an outer left vertical tangent of the tubular wind turbine component position to a fourth contact point on the outer surface where the flexible restraint extends away from the outer surface, and from the fourth contact point to the fourth fixing point,
wherein at least a part of the second restraint path extending between the fourth contact point and the fourth fixing point is oriented along a tangent to the tubular wind turbine component position passing through the fourth contact point,
wherein the first and second flexible restraints are configured to reduce local stress concentrations by reducing a deformation of a tubular wind turbine component in the tubular wind turbine component position when a lateral force, in particular an inertia force resulting from a rolling movement of a vessel or barge on which the tubular wind turbine component is transported, acts on said tubular wind turbine component, wherein the first and second flexible restraints limit an increase in length of the first and second restraint paths resulting from a deformation of said tubular wind turbine component.

By using at least two flexible restrains, a deformation of the tubular wind turbine component resulting from a load acting in a lateral direction (to the left or to the right) can be reduced.

In an embodiment, after step d) and/or step g) the first flexible restraint and/or the second flexible restraint are tensioned.

Even though the method is also effective if the restraints are not tensioned, adding a certain amount of tension further reduces potential deformation of the tubular wind turbine component.

In an embodiment, during step a) the tubular wind turbine component abuts against the saddle and against an end stop being located at a longitudinal distance from a first support assembly, a first support assembly being located between the end stop and a second support assembly. Herein the end stop is configured to transfer a longitudinal force onto a top end or a bottom end of the tubular wind turbine component in the tubular wind turbine component position which prevents the tubular wind turbine component from sliding in the longitudinal direction.

In an embodiment, the tubular wind turbine component is transported using a support assembly according to any of claims 1-18.

In an embodiment, the tubular wind turbine component is transported using a combination according to any of claims 19-26.

In an embodiment, the tubular wind turbine component is transported in a marine environment using a vessel according to claims 29-30.

In some embodiments, a lower part of the recess of the saddle has a radius of curvature R1 which is equal to a radius of curvature R2 which the tubular wind turbine component adopts when deformed under its own weight after being positioned in the saddle, and wherein a left upper part and a right upper part of the saddle have a radius of curvature R3 which is greater than a radius of curvature R2 which the tubular wind turbine component adopts at the left upper part and the right upper part when deformed under its own weight, wherein the tubular wind turbine component contacts the recess in the lower part and does not contact the saddle in the left upper part and right upper part, and wherein as a result, the tubular wind turbine component has play for rolling in the saddle, and wherein the one or more flexible restraints limit the rolling of the tubular wind turbine component.

The invention will be more clearly understood from the following description of some preferred embodiments, which are given by way of example only, with reference to the accompanying drawings.

### BRIEF DESCRIPTION OF THE DRAWINGS

FIGS. 1A, 1B, and 1C show a combination of two support assemblies together with tubular wind turbine components.

FIGS. 2A, 2B, and 2C show a view of the first flexible restraint when viewed along a longitudinal axis of the tubular wind turbine component.

FIGS. 3A-3E show a view of the second flexible restraint when viewed along a longitudinal axis of the tubular wind turbine component and show a saddle from different points of view.

FIGS. 4A, 4B, and 4C show different schematic depictions of the support assembly.

FIGS. 5A and 5B, show a top view of a tubular wind turbine component together with a support assembly.

FIGS. 6A, 6B, and 6C show a support assembly comprising a fixing frame and two flexible restraints.

FIGS. 7A, 7B, and 7C show a support assembly comprising a fixing frame and two flexible restraints

FIGS. 8A and 8B show a vessel configured for transporting multiple tubular wind turbine components.

FIGS. 9A, 9B, and 9C show a vessel in side view in a hogging, neutral, and sagging state.

FIG. 10 shows observed deformation of a tubular wind turbine component in a saddle.

FIG. 11-14 show further embodiments of the present invention.

### DETAILED DESCRIPTION OF THE DRAWINGS

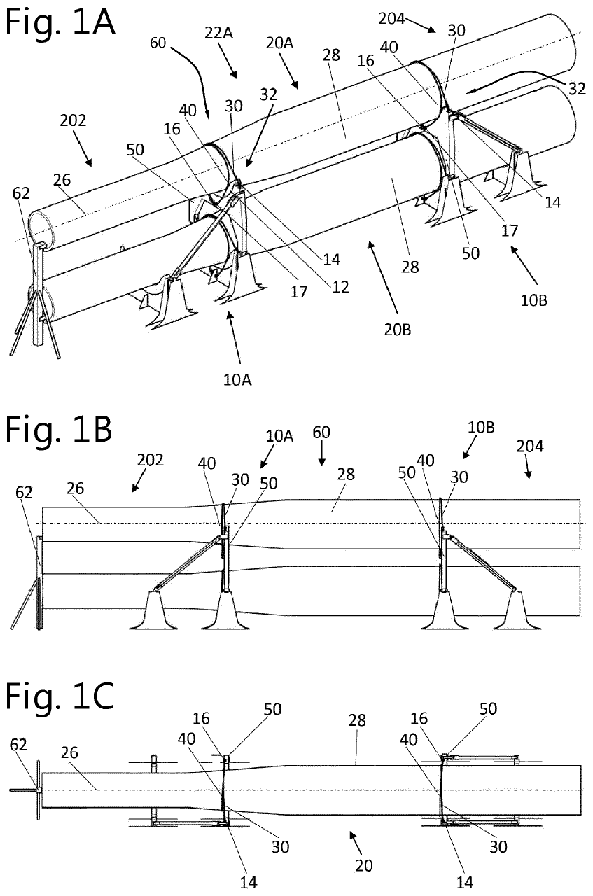

In FIGS. 1A, 1B, and 1C a combination 60 of a first support assembly 10A and a second support assembly 10B that are placed at a longitudinal distance from each other is depicted together with two tubular wind turbine components 20A, 20B. Here, the tubular wind turbine components are wind turbine monopiles that are configured to be embedded in a seabed and to support a wind turbine mast. The combination is described only for the top tubular wind turbine component 20A for reasons of brevity. Near a top end 202 of the tubular wind turbine component 20A, the tubular wind turbine component is supported by the first support assembly 10A. the support assembly defines a tubular wind turbine component position 22A that has a contour and a longitudinal axis 26. The contour and longitudinal axis 26 correspond to an outer surface of the wind turbine component 20A and to the longitudinal axis of the tubular wind turbine component 20A.

The tubular wind turbine component is supported by a saddle 12 that adjoins a lower part of the contour of the tubular wind turbine component. The saddle is oriented transversally to the longitudinal axis 26. The saddle 12 is connected to a fixing frame 50. To support the tubular wind turbine component 20A, the saddle abuts against an outer wall 28 of the tubular wind turbine component. To restrain the tubular wind turbine component, a first flexible restraint 30 and a second flexible restraint 40 are present and extend over the surface of the tubular wind turbine component. These restraints are configured to reduce local stress concentrations by reducing a deformation of the tubular wind turbine component when a lateral force, in particular an inertia force resulting from a rolling movement of a vessel or barge on which the tubular wind turbine component is transported, acts on the tubular wind turbine component. The first and second flexible restraints limit an increase in length of the first and second restraint paths resulting from a deformation of said tubular wind turbine component.

Further, the combination comprises an end stop 62 which is provided near the top end 202 of the tubular wind turbine component, where the first support assembly 10A is located between the end stop 62 and the second support assembly 10B. This end stop is configured to transfer a longitudinal force onto the top end 202 of the tubular wind turbine component which prevents the tubular wind turbine component from sliding in the longitudinal direction. During operation, the tubular wind turbine component may be placed against the end stop 62 when it is placed in the tubular wind turbine component position.

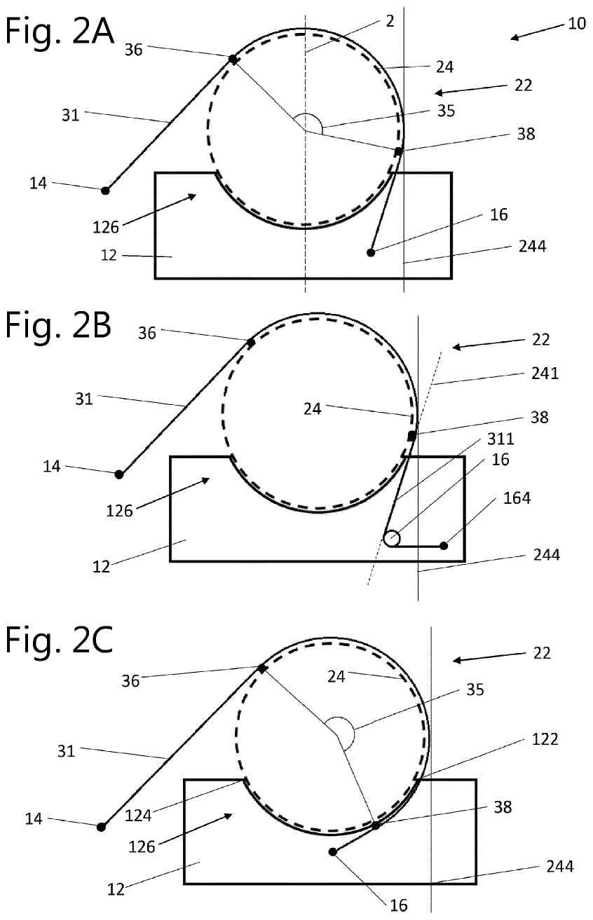

Turning to FIGS. 2A, 2B, and 2C, a schematic representation is provided of a support assembly 10, wherein a first restraint path 31 is depicted. The saddle 12 defines a recess 126 having a shape of a part of a circle which substantially corresponds to a diameter of the tubular wind turbine component for which the saddle is intended to be used. The recess 126 adjoins and substantially matches a part of the contour 24, in particular a lower part, of the tubular wind turbine component position. Here, the longitudinal axis of the tubular wind turbine component position is not depicted because it is oriented transversally to the saddle and extends out of the plane of the drawing. The first restraint path 31 extends over the contour 24, which in use corresponds to an outer surface of the tubular wind turbine component, between a first fixing point 14 and a second fixing point 16 that are fixed relative to the saddle. Here, the second fixing pint 16 is located on the saddle 12, and the first fixing point 14 is not. In use, a first end of the first flexible restraint is configured to be fixed to the first fixing point and a second end of the first flexible restraint is configured to be fixed to the second fixing point.

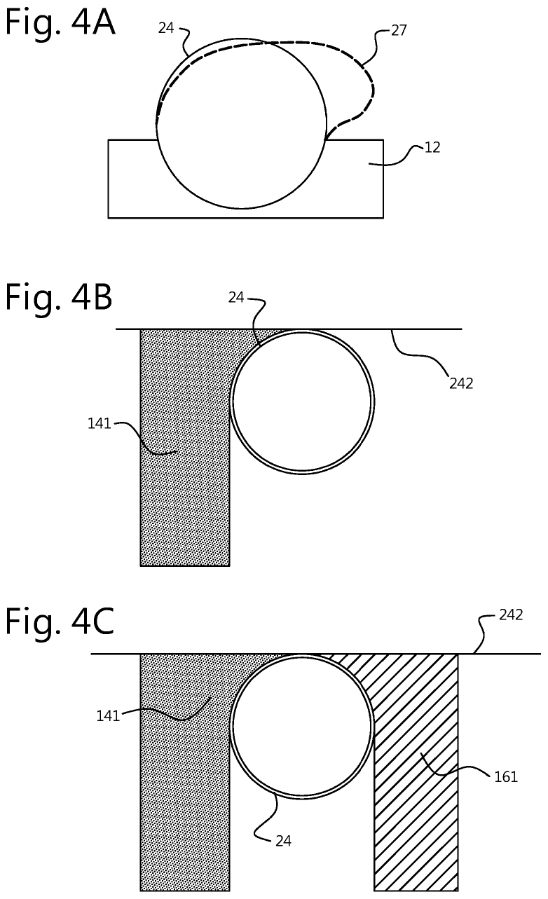

In FIGS. 2A, 2B, and 2C, the first restraint path 31 extends from the first fixing point 14 to a first contact point 36 located on the contour (and in use on the outer surface of the tubular wind turbine component), from the first contact point 36 over and along the contour 24 (and in use over and along the outer surface of the tubular wind turbine component) and to a second contact point 38 on the contour (and in use on the outer surface of the tubular wind turbine component) where the first flexible restraint path 31 extends away from the contour (and in use from the outer surface of the tubular wind turbine component) and from the second contact point 38 to the second fixing point 16. When viewed along the first restraint path 31, the second contact point 38 is located beyond an outer right vertical tangent 244, causing the first restraint path to extend along the contour and beyond the outer right vertical tangent. The first fixing point 14 is located at a position that is in a first fixing region 141 (depicted in FIGS. 4B and 4C). The first fixing region 141 extends on the left of the longitudinal axis, below an upper horizontal tangent 242 of the contour 24, and not vertically underneath the contour 24 (all depicted in FIGS. 4B and 4C).

In FIG. 2A, the part of the first restraint path 31 extending between the second contact point 38 and the second fixing point 16 is completely oriented along a tangent to the contour passing through the second contact point. Here the second fixing point 16 is located vertically underneath the contour. The first and second contact points are located at a circumferential angle 35 of around 150 degrees.

In FIG. 2B, the part 311 of the first restraint path 31 extending between the second contact point 38 and the second fixing point 16 is partially oriented along a tangent 241 to the contour passing through the second contact point 38. The first restraint path further extends past the second fixing point 16, wherein the second fixing point is a sheave, to a first final fixing point 164 being located to the right of the contour 24. A component such as a sheave may be used to guide the first restraint path into the beneficial shape while maintaining a freedom of placement for the second fixing point 16. Similarly, the first restraint path may also extend past the first fixing point 14 being a sheave and to a second final fixing point.

By creating the first restraint path 31 as described above, in use, the first flexible restraint is configured to reduce local stress concentrations by reducing a deformation of the tubular wind turbine component when a force towards the right acts on the tubular wind turbine component. This is achieved by the first flexible restraint limiting an increase in length of the first restraint path resulting from a deformation of said tubular wind turbine component. These forces can in particular be inertia forces resulting from a rolling movement of a vessel or barge on which the tubular wind turbine component is transported. In FIG. 4A, the undeformed contour 24 is depicted together with an exaggerated deformed contour 27. The first flexible restraint is configured to reduce the deformation that leads to the deformed contour.

In FIG. 2C, a similar support assembly is depicted to that of FIG. 2A. However, the second fixing point 16 is located further to the left causing the second contact point 38 to be located, when viewed along the first restraint path 31 from the first fixing point 14 to the second fixing point 16, past an outer right saddle point 122. Such an overlap of saddle and restraint path further reduces potential deformation of the tubular wind turbine component. Here, the first and second contact points are located at a circumferential angle 35 of around 210 degrees.

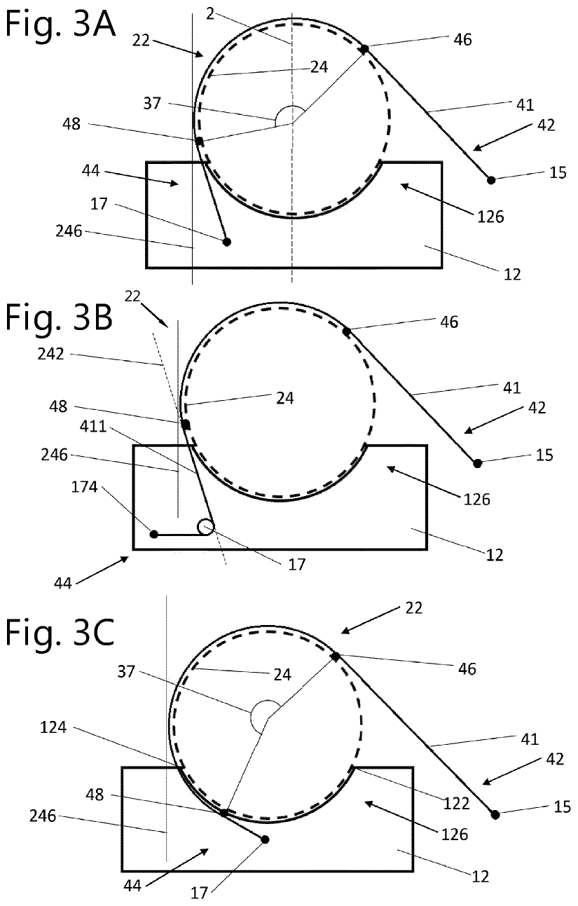

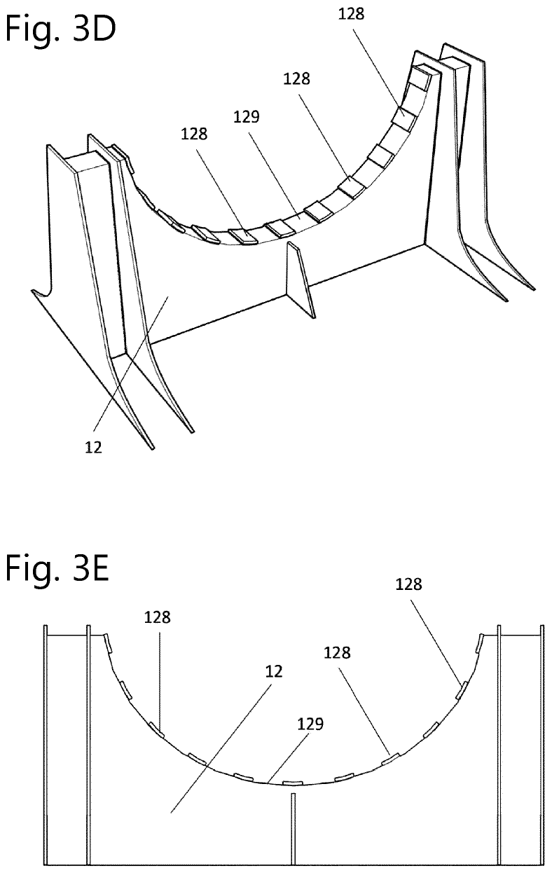

In FIGS. 3A, 3B, and 3C, a support assembly is depicted that further comprises a second flexible restraint 40 that is configured to extend along a second restraint path 41 and that has the same features as the first flexible restrain 30 but is mirrored about a mirror plane 2 that is on a vertical plane extending through the longitudinal axis 26 of the tubular wind turbine component.

The second restraint path 41 extends over the contour 24 between a third fixing point 15 and a fourth fixing point 17 that are fixed relative to the saddle. In use, a first end of the second flexible restraint is configured to be fixed to the third fixing point and a second end of the second flexible restraint is configured to be fixed to the fourth fixing point.

The second restraint path 41 extends from the third fixing point 15 to a third contact point 46 located on the contour, from the third contact point 46 over and along the contour 24 and to a fourth contact point 48 on the contour, where the second flexible restraint path 41 extends away from the and from the fourth contact point 48 to the fourth fixing point 17. When viewed along the second restraint path 41, the fourth contact point 48 is located beyond an outer left vertical tangent 246, causing the second restraint path to extend along the contour and beyond the outer left vertical tangent. The third fixing point 15 is located at a position that is in a second fixing region 161 (depicted in FIG. 4C). The second fixing region 161 extends on the right of the longitudinal axis, below an upper horizontal tangent 242 of the contour 24, and not vertically underneath the contour 24 (all depicted in FIG. 4C).

In FIG. 3A, the part of the second restraint path 41 extending between the second contact point 48 and the fourth fixing point 17 is completely oriented along a tangent to the contour passing through the fourth contact point. Here the fourth fixing point 17 is located vertically underneath the contour. Here, the third and fourth contact points are located at a circumferential angle 37 of around 150 degrees.

In FIG. 3B, the part 411 of the second restraint path 41 extending between the fourth contact point 48 and the fourth fixing point 17 is partially oriented along a tangent 243 to the contour passing through the fourth contact point 48. The second restraint path further extends past a fourth fixing point 17 which is a sheave to a third final fixing point 174 being located to the left of the contour 24. A component such as a sheave may be used to guide the second restraint path into the beneficial shape while maintaining a freedom of placement for the fourth fixing point 17. Similarly, the second restraint path may also extend past the third fixing point 15 being a sheave and to a fourth final fixing point.

By creating the second restraint path 41 as described above together with the first restraint path 31, in use, the first and second flexible restraints are configured to reduce local stress concentrations by reducing a deformation of the tubular wind turbine component when lateral forces acts on the tubular wind turbine component. This is achieved by the first and second flexible restraints limiting an increase in length of the first restraint path and second restraint paths resulting from a deformation of said tubular wind turbine component. These forces can in particular be inertia forces resulting from a rolling movement of a vessel or barge on which the tubular wind turbine component is transported.

In FIG. 3C, a similar support assembly is depicted to that of FIG. 3A. However, the fourth fixing point 17 is located further to the right causing the fourth contact point 48 to be located, when viewed along the second restraint path 41 from the third fixing point 15 to the fourth fixing point 17, past an outer left saddle point 124. Such an overlap of saddle and restraint path further reduces potential deformation of the tubular wind turbine component. Here, the third and fourth contact points are located at a circumferential angle 35 of around 210 degrees.

In operation, first a tubular wind turbine component is placed in the tubular wind turbine component position 22 that is defined by the saddle 12. Subsequently, the first flexible restraint 30 is fixed to one of the first fixing point 14 and the second fixing point 16 and is then passed over the tubular wind turbine component along the first restraint path 31. Thereafter the first flexible restraint 30 is fixed at the other of the first fixing point 14 and the second fixing point 16. Thereafter the first end of the second flexible restraint may be fixed at one of the third fixing point and the fourth fixing point to be subsequently passed over the tubular wind turbine component along the second restraint path 41. Then, the second end of the second flexible restraint is fixed at the other of the third fixing point and the fourth fixing point. If so desired, the first and/or flexible restraint may be tensioned to pre-load the flexible restraints. They may also be kept with some slack.

In FIGS. 3D and 3E, an embodiment of the saddle is depicted where, contrary to FIG. 3A-3C where the tubular wind turbine component was supported by a continuous support surface, the saddle 12 comprises a plurality of support pads 128. These support pads can be made out of a resilient material such as rubber. While still maintaining a support around the outer surface of the tubular wind turbine component, by using pads it is not necessary to coat the entire saddle surface 129.

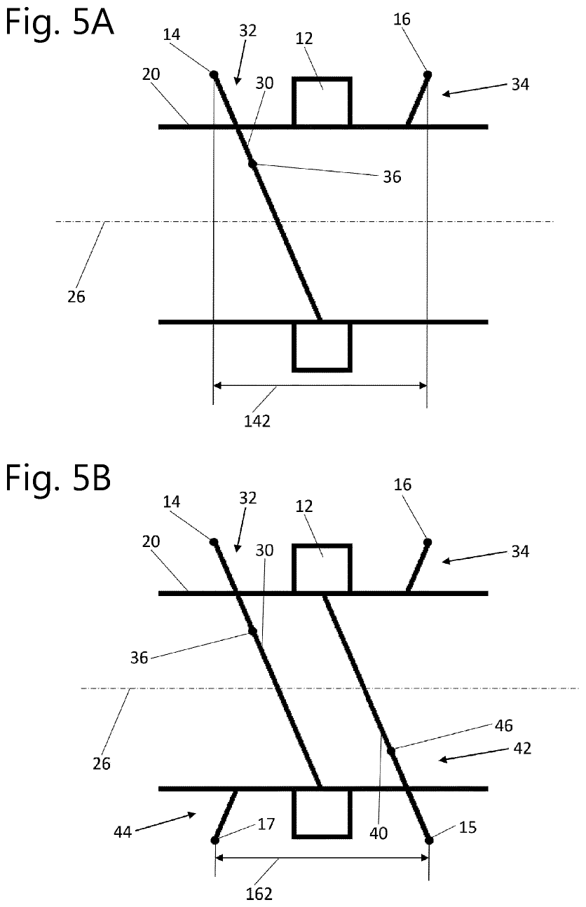

Turning to FIGS. 5A and 5B, a top view of a tubular wind turbine component 20 supported by a support assembly is depicted. In FIG. 5A, the first fixing point 14 is located at a first longitudinal distance 142 from the second fixing point 16 when viewed along the longitudinal axis 26 of the tubular wind turbine component. This allows a part of the first flexible restraint 30 to have a first helical shape which permits the first flexible restraint to counteract any longitudinal forces. In FIG. 5A the first fixing point 14 is located on a front side 125 of the saddle and the second fixing point 16 is located on a rear side 127 of the saddle.

In FIG. 5B, the first flexible restraint 30 is positioned similarly to the way it is positioned in FIG. 5A. A second flexible restraint 40 is also provided that extends between the third fixing point 15 and the fourth fixing point 17. Herein, the third and fourth fixing points are located at a second longitudinal distance 162 from each other when viewed along the longitudinal axis of the tubular wind turbine component. This allows a part of the second flexible restraint 40 to have a second helical shape which permits the second flexible restraint to counteract any longitudinal forces.

Depending on the forces that can be expected or a desired geometry, the first and second fixing point and/or the third and fourth fixing points can be located closer together or further apart. In the case depicted in FIG. 5B, the first and second longitudinal distances 142, 162 are substantially equal causing the first and second flexible restraint to be able to counteract a similar level of longitudinal forces.

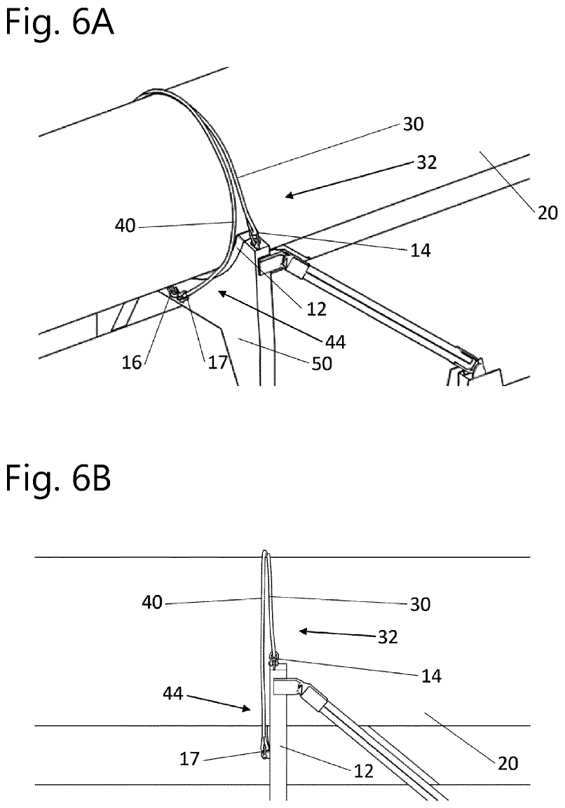

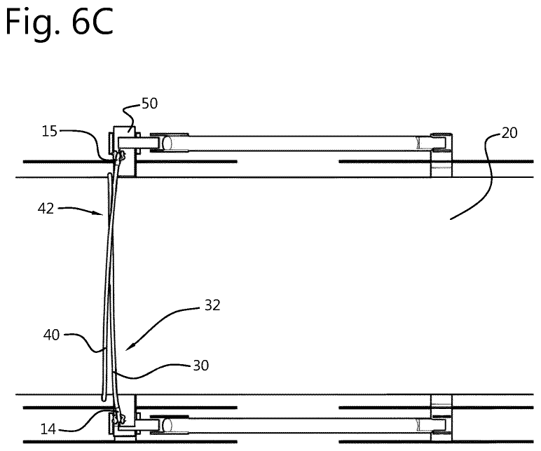

Turning to FIGS. 6A, 6B, and 6C, the first flexible restraint 30 and the second flexible restraint 40 lie in almost a same plane. In this assembly of the tubular wind turbine component 20 and the support assembly, the first flexible restraint extends along the first restraint path and the second flexible restraint 40 extends along the second restraint path 41. The second fixing point 16 and the fourth fixing point 17 are both located on the fixing frame 50 below the tubular wind turbine component 20 and below the saddle 12 that is connected to the fixing frame 50. The first fixing point 14 is also located on the fixing frame but at a higher elevation and next to the tubular wind turbine component 20. The third fixing point 15 is located on an opposite side of the tubular wind turbine component.

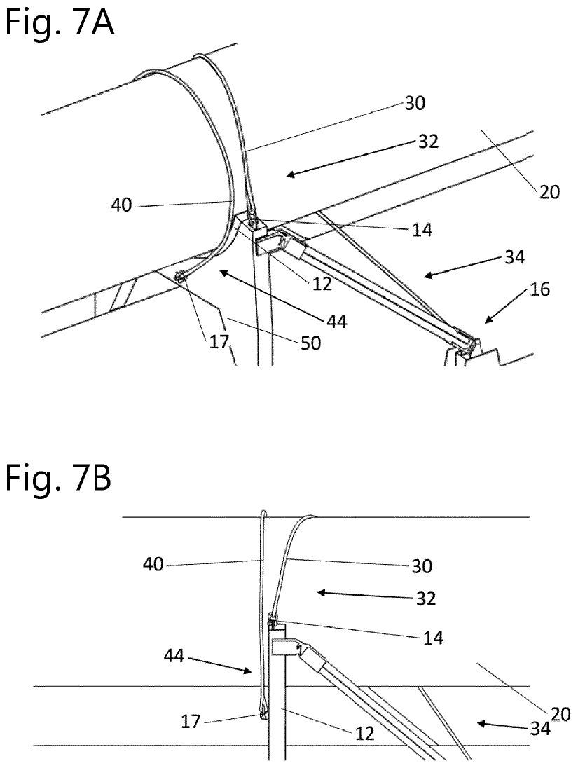

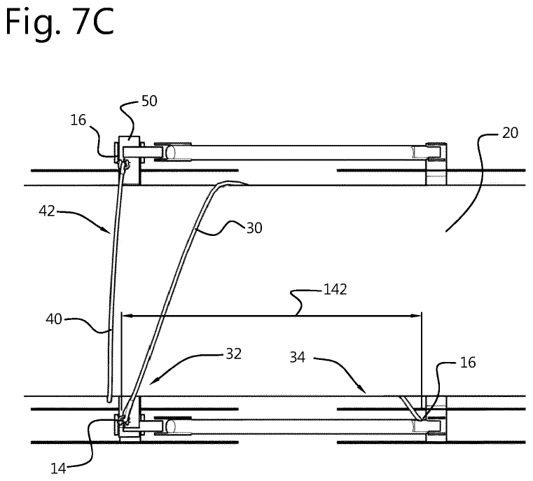

Turning to FIGS. 7A, 7B, and 7C, the second flexible restraint 40 is provided in a similar way as in FIGS. 6A, 6B, and 6C. The first flexible restraint 30 is provided in a different manner. Because the second fixing point 16 has been placed at the first longitudinal distance 142 from the first fixing point 14, the first flexible restraint has a first helical shape. The pitch of the helical shape is about 125% of the diameter of the contour but may be varied through the choice of the longitudinal distance. The first flexible restraint may counteract more longitudinal forces than it could in FIGS. 6A, 6B, and 6C.

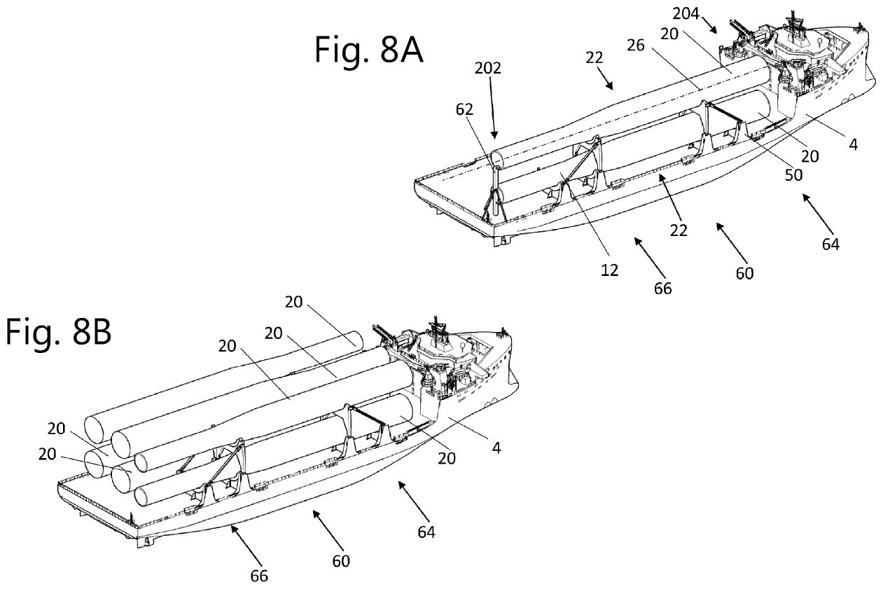

In FIGS. 8A and 8B, a vessel 4 is shown that is configured to transport a combination 60 of multiple support assemblies being configured for restraining multiple tubular wind turbine components in as many multiple tubular wind turbine component positions. A support frame 61 is integrated into the vessel and comprises a front portion 64 that is located near the bow and a rear portion 66 located near the aft of the vessel 4. Both the front portion and the rear portion comprise a plurality of tubular wind turbine component support assemblies according to any of claims 1-18. Herein, each support assembly is connected to the support frame.

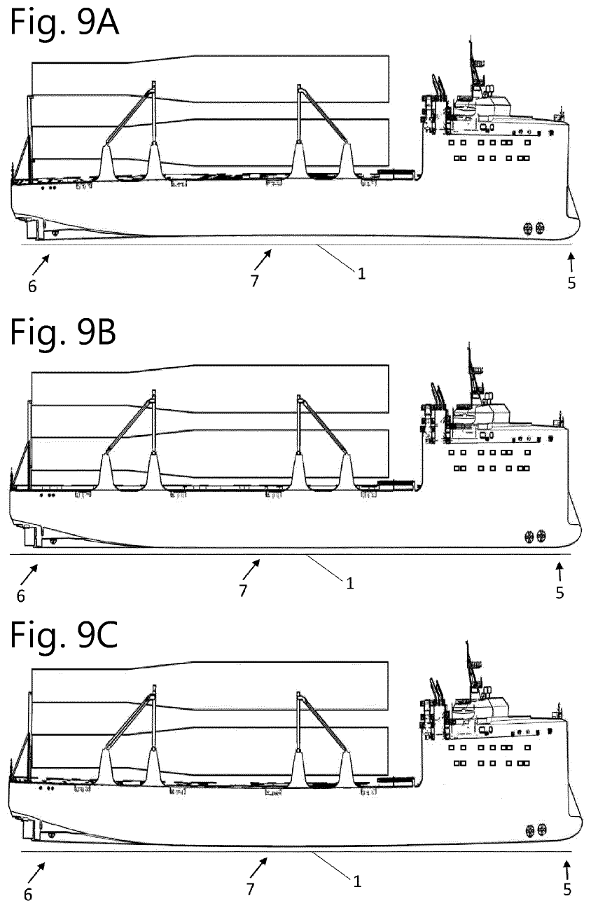

In FIGS. 9A, 9B, and 9C, three common states are shown in which a vessel might find itself. Due to the motion of the sea, different points along the vessel may experience different loads; this results in three main deformation states of the vessel. When, for example, a wave crest is located near the middle 7 of the vessel and wave troughs are located near the bow 5 and aft 6, the vessel is in a so-called hogging state; the middle 7 of the vessel is further away from the horizontal 1 than the bow and aft. In FIG. 9B, no vessel deformation is present; this is considered a neutral state. In FIG. 9C, a sagging state is depicted. Herein, the bow 5 and aft 6 may be located near a wave crest while the middle 7 is located near a wave trough. The bow and aft are further away from the horizontal than the middle of the vessel.

When a tubular wind turbine component is fixated relative to the vessel and the vessel starts to hog or sag, a load is applied to the tubular wind turbine component for which it was not designed and which it is not well capable of handling. In order to prevent unnecessary loading, a degree of freedom can be integrated in any of the support assembly, the support frame, or the vessel. This creates a simply supported beam construction and can be achieved in multiple ways.

The saddle of the support assembly, in particular the continuous support surface or the plurality of support pads, may comprise a slippery surface configured to allow a tubular wind turbine component to slide over the surface in at least a longitudinal direction without transferring a substantial longitudinal force onto the saddle.

A connection between the support assembly and the support frame can comprise a first compliant component that is configured to create at least one degree of freedom between the support assembly and the support frame, wherein the first compliant component is a torsion spring, tension spring, or compression spring. The support frame may also comprise a second compliant component that is configured to create an internal degree of freedom and may be a torsion spring, tension spring, or compression spring. Also, both the first and second compliant components may further comprise a damper and may be located at the rear portion of the support frame.

Also, at least one support assembly may be translationally connected to the vessel in a longitudinal direction forming a free bearing and another support assembly forms a fixed bearing. Herein the fixed bearing and the free bearing are configured to allow hogging and/or sagging of the vessel without a substantial load transmittal into the tubular wind turbine component and form a simply supported beam construction.

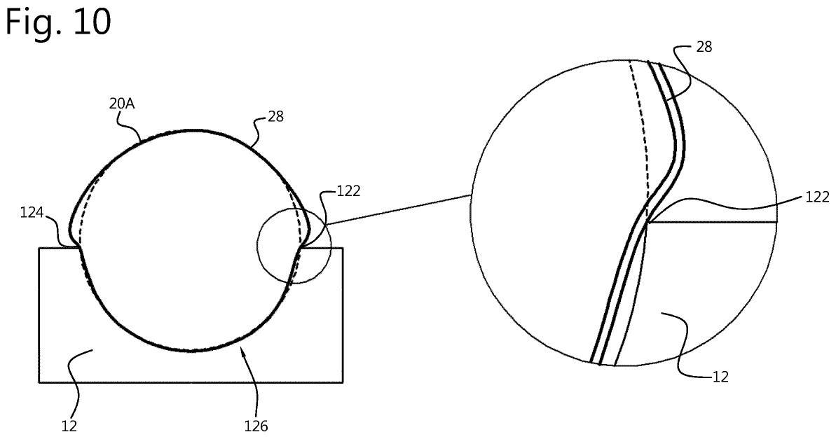

Turning to FIG. 10, it was observed in the present invention that a tubular wind turbine component 20A in the saddle 12 may deform under the influence of gravity, in other words under its own weight. The deformation can in particular be significant at the outer right saddle point 122 and outer left saddle point 124. The outer wall 28 of the tubular wind turbine component 20A may bulge outward just above the outer right saddle point 122 and outer left saddle point 124 and may bulge inward just below the outer right saddle point 122 and outer left saddle point 124. As a result, a point load or at least a locally increased load may occur at the outer right saddle point 122 and outer left saddle point 124. It is noted that the figure shows the deformations in an enlarged view for clarity.

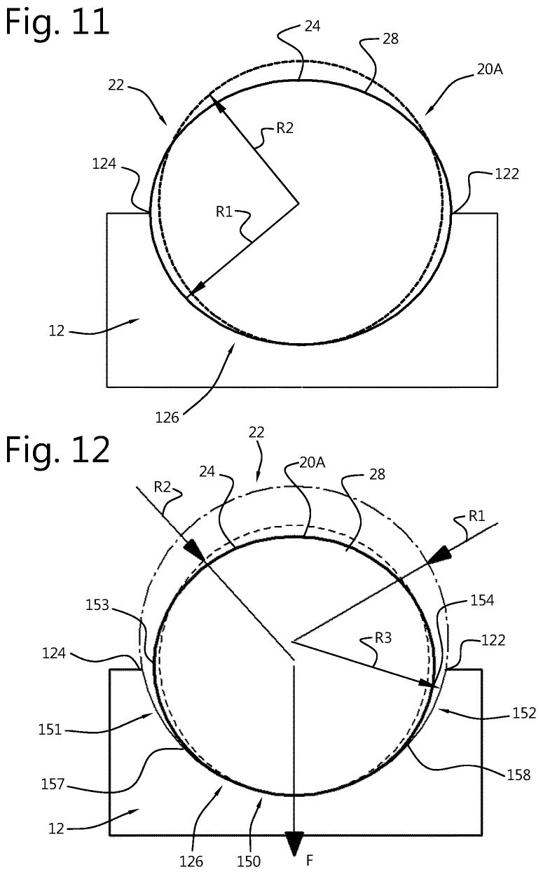

Turning to FIG. 11, the shape of the recess 126 of the saddle can also be (partly) adapted to the contour 24 of the tubular wind turbine component after the deformation thereof. In this way, local stresses in the outer wall 28 of the tubular wind turbine component can be further decreased. The recess 126 of the saddle has a radius of curvature R1 which is greater than a radius of curvature R2 of the tubular wind turbine component in a non-deformed state. In FIG. 11 the recess 126 has an oval shape. Another benefit is that loading onto the outer pads is reduced allowing for smaller pads and/or reduced compressive resistance in the rubber allowing for cheaper pad material.

The shape may be oval or may have a different curvature, in particular a polynomial curvature, but may also be circular with a larger radius of curvature than the non-deformed tubular wind turbine component.

In this way, the tubular wind turbine component 20A may contacts the recess 126 over the full circumferential length of the recess 126, but the tensions in the wall 28 are smaller than they would be if the recess would have a radius of curvature equal to the radius of curvature of (the contour 24 of) the non-deformed tubular wind turbine component.

Turning to FIG. 12, it was further recognized in the present invention a further advantage can be obtained when a lower part 150 of the recess 126 has a radius of curvature R1 which is equal to a radius of curvature R2 which the tubular wind turbine component 20A adopts when deformed under its own weight after being positioned in the saddle and to provide a left upper part 151 and a right upper part 152 of the saddle with a radius of curvature R3 which is greater than a radius of curvature which the tubular wind turbine component adopts at the left upper part and right upper part when deformed under its own weight. As a result, the tubular wind turbine component 20A contacts the saddle 12 in the lower part 150 and does not contact the saddle in the left upper part 151 and right upper part 152. The transition between the lower part 150 and the left and right upper part is located at a left engagement point 157 respectively a right contact point 158. This configuration allows some rolling of the tubular wind turbine component without hitting any outer left or outer right saddle point 124, 122. As a result of the rolling movement, the positions of the left and right engagement point 157, 158 will shift. Rolling has negative effects, including wear on the pads, if present. Also rolling results has a negative effect on the capability of the saddle to support the tubular wind turbine component in the longitudinal direction, because the friction is dynamic friction rather than static friction. Dynamic friction is lower. Also, in general loose cargo is not desired on a vessel.

It is noted that the radius of curvature of the deformed tubular wind turbine component will generally be non-uniform. The radius of curvature will be smaller (meaning a stronger curvature) near the outermost left and right areas 153, 154 of the deformed tubular wind turbine component as seen in FIG. 12 and will be relatively greater in the lower region where the deformed tubular wind turbine component contacts the saddle. The shape of the recess may be chosen to be circular with a sufficiently large radius to achieve the desired configuration, and in this configuration R1 and R3 would actually be equal. However, the shape of the recess 126 may also be different and for instance have a non-uniform radius of curvature, such as oval or with a different curvature. In such an embodiment, R 1 and R3 are not equal.

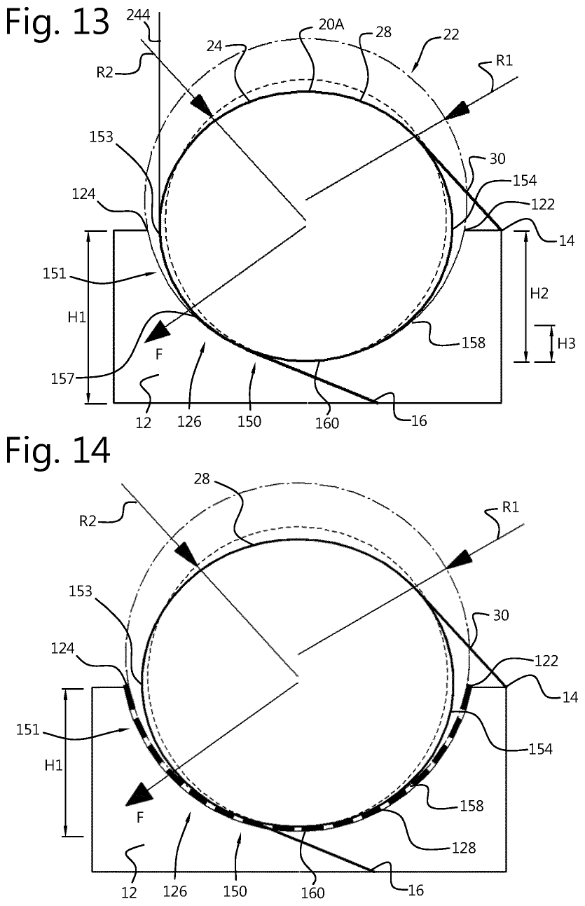

Turning to FIG. 13, it was found that this configuration provides advantages in combination with the flexible restraint(s) 30. The recess 126 provides some play for the tubular wind turbine component 20A to roll from left to right and vice versa. The flexible restraints 30, arranged in the manner discussed above, maintain the tubular wind turbine component 20A in position or at least limit the rolling movement. Only one flexible restraint 30 is shown in FIG. 13, but the skilled person will understand that a mirrored flexible restraint 30 will also be present. FIG. 13 also shows the configuration in a mirrored manner relative to FIGS. 2A-2C and 3A-3C with the result that the first and second fixing point 14, 16 have switched positions.

It was found that with the restraints picking up part of the horizontal load and reducing the stresses on the pads and the local stresses in the pile wall, the saddle height H1 may be reduced, allowing for significant steel savings. Where the steel saddles are typically made for one project, the restraints can be reused by slightly shifting the fixing points based on the diameter of the pile or by shortening or lengthening a built in tensioning system, where tensioning can be done either to take out slack or partly pretension the restraints.

The lower part of the recess 126 has a radius of curvature which matches the radius of curvature which the deformed tubular wind turbine component 20A adopts when deformed under its own weight after being positioned in the saddle 12.

The saddle 12 has a height H1, and the recess 126 has a height H2, measured from a lowest point 160 of the recess to the left and right outer saddle points 122, 124. The tubular wind turbine component contacts the recess 126 over a height H3. Preferably, H3/H2 is between 0,1 and 0,5. It was found that in this range the tensions in the outer wall during transport remain in particular low.

Turning to FIG. 14, the recess 126 which is wider than the deformed tubular wind turbine component also works with pads 128 as discussed for FIGS. 3D and 3E. The pads may be straight or curved. The pads may be evenly spaced over fully defined saddle shape or have sections where no pads are present or moreover have pads concentrated on certain sections. A typical example is to omit the pads at the 6 'o-clock position.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising i.e., open language, not excluding other elements or steps.

Any reference signs in the claims should not be construed as limiting the scope of the claims or the invention. It will be recognized that a specific embodiment as claimed may not achieve all of the stated objects.

The mere fact that certain measures are recited in mutually different dependent claims does not indicate that a combination of these measures cannot be used to advantage.

White lines between text paragraphs in the text above indicate that the technical features presented in the paragraph may be considered independent from technical features discussed in a preceding paragraph or in a subsequent paragraph.

1.-41. (canceled)

42. A support assembly for transporting a tubular wind turbine component, in particular on a transport vessel at sea, the support assembly defining a tubular wind turbine component position having a contour and a longitudinal axis, wherein the contour corresponds to an outer surface of the tubular wind turbine component that in use is located in the tubular wind turbine component position and the longitudinal axis corresponds to a longitudinal axis of the tubular wind turbine component that in use is located in the tubular wind turbine component position, wherein the tubular wind turbine component is a turbine mast or a monopile, and wherein the support assembly comprises:
a saddle which defines a concave recess that adjoins a lower part of the contour of the tubular wind turbine component position, wherein the longitudinal axis of the tubular wind turbine component position is oriented transversally to the saddle, and
wherein the concave recess is configured to abut against an outer surface of a wall of a tubular wind turbine component in the tubular wind turbine component position,
a first fixing point and a second fixing point for attaching respectively a first end and a second end of a first flexible restraint, wherein the first fixing point and the second fixing point are configured to be fixed relative to the saddle,
the first flexible restraint comprising the first end and second end, wherein the first fixing point, the second fixing point and the contour define a first restraint path along which in use the first flexible restraint extends, wherein in use the first restraint path extends over the tubular wind turbine component between the first fixing point and the second fixing point and contacts an outer surface of the tubular wind turbine component,
wherein when viewed in a direction of the longitudinal axis of the tubular wind turbine component position the first fixing point is located:
on the left of the longitudinal axis, and
below an upper horizontal tangent of the contour, and
not vertically underneath the contour,
wherein in use the first restraint path extends from the first fixing point to a first contact point on the outer surface of the tubular wind turbine component in the tubular wind turbine component position, from the first contact point over the tubular wind turbine component and along the surface of the tubular wind turbine component and beyond an outer right vertical tangent of the tubular wind turbine component position to a second contact point on the outer surface where the flexible restraint extends away from the outer surface, and from the second contact point to the second fixing point, wherein the second fixing point is located to the left and below the second contact point,
wherein at least a part of the first restraint path extending between the second contact point and the second fixing point is oriented along a tangent to the contour passing through the second contact point,
wherein the first flexible restraint is configured to reduce local stress concentrations by reducing a deformation of the tubular wind turbine component when a force towards the right, in particular an inertia force resulting from a rolling movement of a vessel or barge on which the tubular wind turbine component is transported, acts on said tubular wind turbine component, wherein the first flexible restraint limits an increase in length of the first restraint path resulting from a deformation of said tubular wind turbine component.

43. The support assembly according to claim 42, further comprising at least a second flexible restraint having the same features as the first flexible restraint, but mirrored around a mirror axis or about a mirror plane on a vertical plane which extends through the longitudinal axis, said features being, when viewed along the longitudinal axis of the tubular wind turbine component position;
a third fixing point and a fourth fixing point for attaching respectively a first end and a second end of the second flexible restraint, wherein the third fixing point and the fourth fixing point are configured to be fixed relative to the saddle,
the second flexible restraint comprising the first end and second end, wherein the third fixing point, the fourth fixing point and the contour define a second restraint path along which in use the second flexible restraint extends, wherein in use the second restraint path extends over the tubular wind turbine component between the third fixing point and the fourth fixing point and contacts the outer surface of the tubular wind turbine component,
wherein when viewed in a direction of the longitudinal axis of the tubular wind turbine component position the third fixing point is located:
on the right of the longitudinal axis, and
below the upper horizontal tangent of the contour, and
not vertically underneath the contour,
wherein in use the second restraint path extends from the third fixing point to a third contact point on the outer surface of the tubular wind turbine component in the tubular wind turbine component position, from the third contact point over the tubular wind turbine component and along the surface of the tubular wind turbine component past an outer left vertical tangent of the tubular wind turbine component position to a fourth contact point on the outer surface where the flexible restraint extends away from the outer surface, and from the fourth contact point to the fourth fixing point, wherein the fourth fixing point is located to the right and below the fourth contact point,
wherein at least a part of the second restraint path extending between the fourth contact point and the fourth fixing point is oriented along a tangent to the tubular wind turbine component position passing through the fourth contact point,
wherein the first and second flexible restraints are configured to reduce local stress concentrations by reducing a deformation of a tubular wind turbine component in the tubular wind turbine component position when a lateral force, in particular an inertia force resulting from a rolling movement of a vessel or barge on which the tubular wind turbine component is transported, acts on said tubular wind turbine component, wherein the first and second flexible restraints limit an increase in length of the first and second restraint paths resulting from a deformation of said tubular wind turbine component.

44. The support assembly according to claim 42, wherein the saddle comprises an outer right saddle point which marks an end of the saddle on the right side thereof, wherein the second contact point is located past the outer right saddle point when viewed along the first restraint path from the first fixing point to the second fixing point, and/or
wherein the saddle comprises an outer left saddle point which marks an end of the saddle on the left side thereof, wherein the fourth contact point is located past the outer left saddle point when viewed along the second restraint path from the third fixing point to the fourth fixing point.

45. The support assembly according to claim 42, wherein the first contact point and the second contact point are located at a circumferential angle of 150-210 degrees from each other over the outer surface of the tubular wind turbine component, in particular 165-195 degrees, more in particular 180 degrees, and/or
wherein the third contact point and the fourth contact point are located at a circumferential angle of 150-210 degrees from each other over the outer surface of the tubular wind turbine component, in particular 165-195 degrees, more in particular 180 degrees.

46. The support assembly according to claim 45, wherein the recess has a shape of a part of a circle which, in particular, substantially corresponds to a diameter of a tubular wind turbine component for which the saddle is intended to be used, wherein the saddle in particular has a shape of a circumferential angle of at least 70 degrees, more in particular 100-180 degrees, even more in particular 100-140 degrees.

47. The support assembly according to claim 42, wherein the first fixing point is located at a first longitudinal distance from the second fixing point when viewed along the longitudinal axis of the tubular wind turbine component, allowing the part of the first flexible restraint which in use contacts the tubular wind turbine component to have a first helical shape, in particular the first fixing point being located on a front side or a rear side of the saddle and the second point being located on the other side than the first fixing point.

48. The support assembly according to claim 43, wherein the third fixing point is located at a second longitudinal distance from the fourth fixing point when viewed along the longitudinal axis of the tubular wind turbine component position, allowing the part of the second flexible restraint which in use contacts the tubular wind turbine component to have a second helical shape, in particular the third fixing point being located on a front side or a rear side of the saddle and the fourth point being located on the other side than the third fixing point.

49. The support assembly according to claim 42, wherein at least one fixing point is located on the saddle.

50. The support assembly according to claim 42, wherein at least one flexible restraint comprises a gripping member having a gripping surface, comprises a gripping layer or comprises a gripping coating, configured to, when in use, prevent the slipping of the at least one restraint relative to a tubular wind turbine component in the tubular wind turbine component position.

51. An assembly of at least one support assembly according to claim 42 and a tubular wind turbine component being a turbine mast or a monopile, wherein the tubular wind turbine component abuts against the saddle in the tubular wind turbine component position and wherein at least the first flexible restraint extends over the tubular wind turbine component and extends between the first fixing point and the second fixing point along the first restraint path.

52. The assembly according to the previous claim 51, wherein the saddle has a recess having a radius of curvature which is greater than a radius of curvature of the tubular wind turbine component in a non-deformed state.

53. The assembly according to claim 52, wherein a lower part of the recess of the saddle has a radius of curvature which is equal to a radius of curvature which the tubular wind turbine component adopts when deformed under its own weight after being positioned in the saddle, and wherein a left upper part and a right upper part of the saddle have a radius of curvature which is greater than a radius of curvature which the tubular wind turbine component adopts at the left upper part and the right upper part when deformed under its own weight, wherein the tubular wind turbine component contacts the recess in the lower part and does not contact the saddle in the left upper part and right upper part.

54. A vessel for the transporting of tubular wind turbine components, comprising a support assembly according to claim 42 and/or an assembly according to claim 51.

55. The vessel according to claim 54, wherein at least a first support assembly is translationally connected to the vessel in a longitudinal direction, wherein the first support assembly may translate relative to the vessel, forming a free bearing and wherein another support assembly forms a fixed bearing and is located at a distance from the first support assembly, wherein the fixed bearing and the free bearing are configured to allow hogging and/or sagging of the vessel without a substantial load transmittal into the tubular wind turbine component.

56. A method for transporting a tubular wind turbine component with a support assembly, in particular on a transport vessel at sea, the support assembly defining a tubular wind turbine component position having a contour and a longitudinal axis, wherein the contour corresponds to an outer surface of the tubular wind turbine component that is located in the tubular wind turbine component position and the longitudinal axis corresponds to a longitudinal axis of the tubular wind turbine component that in use is located in the tubular wind turbine component position, wherein the tubular wind turbine component is a turbine mast or a monopile, and wherein the support assembly comprises:
a saddle which defines a concave recess that adjoins a lower part of the contour of the tubular wind turbine component position wherein the longitudinal axis of the tubular wind turbine component position is oriented transversally to the saddle, and wherein the concave recess is configured to abut against an outer surface of a wall of the tubular wind turbine component in the tubular wind turbine component position, a first fixing point and a second fixing point for attaching respectively a first end and a second end of a first flexible restraint, wherein the first fixing point and the second fixing point are configured to be fixed relative to the saddle,
wherein when viewed in a direction of the longitudinal axis of the tubular wind turbine component position the first fixing point is located:
on the left of the longitudinal axis, and
below an upper horizontal tangent of the contour, and
not vertically underneath the contour,
wherein the method comprises the steps;
a) placing a tubular wind turbine component in the tubular wind turbine component position defined by the saddle,
b) fixing the first end of the first flexible restraint at one of the first fixing point and second fixing point,
c) passing the first flexible restraint over the tubular wind turbine component along a first restraint path,
d) fixing the second end of the first flexible restraint at the other of the first fixing point and second fixing point,
wherein the first restraint path extends from the first fixing point to a first contact point on an outer surface of the tubular wind turbine component in the tubular wind turbine component position, from the first contact point over the tubular wind turbine component and along the surface of the tubular wind turbine component past an outer right vertical tangent of the tubular wind turbine component position to a second contact point on the outer surface where the flexible restraint extends away from the outer surface, and from the second contact point to the second fixing point, wherein the second fixing point is located to the left and below the second contact point,
wherein at least a part of the first restraint path extending between the second contact point and the second fixing point is oriented along a tangent to the tubular wind turbine component position passing through the second contact point,
wherein the first flexible restraint is configured to reduce local stress concentrations by reducing a deformation of a tubular wind turbine component in the tubular wind turbine component position when a force towards the right, in particular an inertia force resulting from a rolling movement of a vessel or barge on which the tubular wind turbine component is transported, acts on said tubular wind turbine component, wherein the first flexible restraint limits an increase in length of the first restraint path resulting from a deformation of said tubular wind turbine component.

57. The method according to claim 56, wherein the support assembly further comprises at least a second flexible restraint having the same features as the first flexible restraint, but mirrored around a mirror point or about a mirror plane on a vertical plane which extends through the longitudinal axis, said features being, when viewed along the longitudinal axis of the tubular wind turbine component position;
a third fixing point and a fourth fixing point for attaching respectively a first end and a second end of the second flexible restraint, wherein the third fixing point and the fourth fixing point are configured to be fixed relative to the saddle,
wherein when viewed in a direction of the longitudinal axis of the tubular wind turbine component position the third fixing point is located:
on the right of the longitudinal axis, and
below the upper horizontal tangent of the contour, and
not vertically underneath the contour,
wherein the method further comprises the steps;
e) fixing the first end of the second flexible restraint at one of the third fixing point and the fourth fixing point,
f) passing the second flexible restraint over the tubular wind turbine component along a second restraint path,
g) fixing the second end of the second flexible restraint at the other of the second fixing point and fourth fixing point,
wherein the second restraint path extends from the third fixing point to a third contact point on the outer surface of the tubular wind turbine component in the tubular wind turbine component position, from the third contact point over the tubular wind turbine component and along the surface of the tubular wind turbine component past an outer left vertical tangent of the tubular wind turbine component position to a fourth contact point on the outer surface where the flexible restraint extends away from the outer surface, and from the fourth contact point to the fourth fixing point, wherein the fourth fixing point is located to the right and below the fourth contact point,
wherein at least a part of the second restraint path extending between the fourth contact point and the fourth fixing point is oriented along a tangent to the tubular wind turbine component position passing through the fourth contact point,
wherein the first and second flexible restraints are configured to reduce local stress concentrations by reducing a deformation of a tubular wind turbine component in the tubular wind turbine component position when a lateral force, in particular an inertia force resulting from a rolling movement of a vessel or barge on which the tubular wind turbine component is transported, acts on said tubular wind turbine component, wherein the first and second flexible restraints limit an increase in length of the first and second restraint paths resulting from a deformation of said tubular wind turbine component.

58. The method according to claim 56, wherein after step d) and/or step g) the first flexible restraint and/or the second flexible restraint are tensioned.

59. The method according to claim 56, wherein during step a) the tubular wind turbine component abuts against the saddle and against an end stop being located at a longitudinal distance from a first support assembly, a first support assembly being located between the end stop and a second support assembly, wherein the end stop is configured to transfer a longitudinal force onto a top end or a bottom end of the tubular wind turbine component in the tubular wind turbine component position which prevents the tubular wind turbine component from sliding in the longitudinal direction.

60. The method according to claim 56, wherein the tubular wind turbine component is transported using a support assembly according to claim 42.

61. The method according to claim 56, wherein a lower part of the recess of the saddle has a radius of curvature which is equal to a radius of curvature which the tubular wind turbine component adopts when deformed under its own weight after being positioned in the saddle, and wherein a left upper part and a right upper part of the saddle have a radius of curvature which is greater than a radius of curvature which the tubular wind turbine component adopts at the left upper part and the right upper part when deformed under its own weight, wherein the tubular wind turbine component contacts the recess in the lower part and does not contact the saddle in the left upper part and right upper part, and wherein as a result, the tubular wind turbine component has play for rolling in the saddle, and wherein the one or more flexible restraints limit the rolling of the tubular wind turbine component.
